(19) United States
(12) Patent Application Publication
(10) Pub. No.: US 2020/0124918 A1
(43) Pub. Date: Apr. 23, 2020

(54) LIGHTING APPARATUS AND LIQUID CRYSTAL DISPLAY APPARATUS

(71) Applicant: SHARP KABUSHIKI KAISHA, Osaka (JP)

(72) Inventors: HISASHI WATANABE, Osaka (JP); HIROTOSHI YASUNAGA, Osaka (JP); YOUZOU KYOUKANE, Osaka (JP); TAKESHI MASUDA, Osaka (JP)

(21) Appl. No.: 16/653,531

(22) Filed: Oct. 15, 2019

Related U.S. Application Data
(60) Provisional application No. 62/749,051, filed on Oct. 22, 2018.

(51) Int. Cl. G02F 1/1335; G02F 1/1339; G02F 1/1333

(52) U.S. Cl. CPC G02F 1/133605; G02F 1/133308; G02F 1/1339

(57) ABSTRACT

Provided is a lighting apparatus and a liquid crystal display apparatus that, even when a plurality of light sources are arranged with a narrow pitch, support an optical member without bending and can prevent breakage of a light source caused by the optical member contacting the light source.

### TECHNICAL FIELD

The present invention relates to a lighting apparatus including an optical member in a front surface of a light source, and a liquid crystal display apparatus.

### BACKGROUND ART

A liquid crystal display apparatus of a transmission type needs a lighting apparatus that radiates light from a back surface of a liquid crystal panel in which an image is displayed. As the lighting apparatus, there are a lighting apparatus of an edge light type and a lighting apparatus of a direct type. The lighting apparatus of the edge light type guides light emitted from a light source arranged in an edge surface of a light guide plate and performs planar light emission. The lighting apparatus of the direct type has a plurality of light sources arranged directly below a liquid crystal panel with a predetermined interval and performs planar light emission.

A technique called “HDR” that achieves an extremely wide dynamic range has been increasingly adopted in recent years. The HDR is able to be achieved by performing driving of partial lighting called local dimming in the lighting apparatus of the direct type. Further, in the lighting apparatus of the direct type, many light sources are able to be arranged, so that high luminance is also easily achieved.

In general, in the lighting apparatus of the direct type, many light sources are arranged with a predetermined pitch and an optical member for diffusing light is arranged at a position facing each of the light sources. Meanwhile, when trying to achieve high luminance in the lighting apparatus of the direct type, the number of light sources increases and the optical member is apt to be affected by heat generated from the light source. Thereby, the optical member is bent, which causes luminance unevenness. Further, when the optical member is bent, the optical member and the light source contact, which causes damage of the light source. In addition, for use in a vibrational situation such as on-vehicle use, the optical member and the light source contact and the light source may be damaged.

As means of solving such a problem in the lighting apparatus of the direct type, for example, PTL 1 proposes a method of preventing an optical member from being bent by providing a support body in a gap between a plurality of light sources that are arranged.

For appropriately supporting a diffuser plate that is an optical member, the support body as described above is fixed by a fixing protrusion being inserted into a fixing hole provided in an under chassis. In order to avoid a case where shadow is formed due to light emitted from a light source being blocked by the support body, the support body is formed to be tapered as much as possible and is generally in point contact with the diffuser plate.

### CITATION LIST

### Patent Literature

[PTL 1] Japanese Unexamined Patent Application Publication No. 2013-161793

### SUMMARY OF INVENTION

### Technical Problem

Meanwhile, as an HDR-compatible lighting apparatus of the direct type has higher luminance, approaches have been recently made to mount light sources on a substrate so that a pitch of the light sources is as narrow as possible. However, since the light sources are arranged with the narrow pitch, it is difficult to secure a space where a support body is installed.

A general support body is manufactured by resin molding using a mold and there is limitation to size reduction. Moreover, even when the molding is able to be performed, an insert portion by which the small support body is fixed onto the substrate becomes too thin and is broken during use in some cases. Further, though fixation with use of tape or adhesive is also considered, an adhesive force is insufficient because an adhesive area is small, so that it is difficult to perform fixing firmly.

An embodiment of the invention aims to provide a lighting apparatus and a liquid crystal display apparatus in which an optical member is not bent even when a plurality of light sources are arranged with a narrow pitch.

### Solution to Problem

(1) An embodiment of the invention is a lighting apparatus including: a substrate; a plurality of light sources each of which has a light output surface and which are arranged on the substrate; an optical member that is arranged at a position facing the light output surface of each of the light sources; and a support body that supports the optical member and has a height from a surface of the substrate higher than a height to the light output surface, in which the support body is arranged between the substrate and the optical member, and includes a support part that has a light transmission property and an opening corresponding to at least one of the plurality of light sources as viewed from a direction normal to the substrate.

(2) Moreover, an embodiment of the invention is the lighting apparatus in which the support body includes an adhesive layer arranged between the support part and the substrate, in addition to the configuration of (1) described above.

(3) Moreover, an embodiment of the invention is the lighting apparatus in which the support body includes a reflection layer arranged between the support part and the adhesive layer, in addition to the configuration of (2) described above.

(4) Moreover, an embodiment of the invention is the lighting apparatus in which the support body includes an insulating reflection surface arranged between the support part and the substrate, in addition to the configuration of (1), (2), or (3) described above.

(5) Moreover, an embodiment of the invention is the lighting apparatus in which the support part includes a top surface part provided at a top surface, in addition to the configuration of (1) described above.

(6) Moreover, an embodiment of the invention is the lighting apparatus in which the top surface part contacts the optical member, in addition to the configuration of (5) described above.

(7) Moreover, an embodiment of the invention is the lighting apparatus in which the adhesive layer has a light transmission property, in addition to the configuration of (2) described above.

(8) Moreover, an embodiment of the invention is the lighting apparatus in which a thickness of the reflection layer is 0.1 to 10 μm or less, in addition to the configuration of (3) described above.

(9) Moreover, an embodiment of the invention is the lighting apparatus in which a shape of the opening is circular as viewed from the direction normal to the substrate, in addition to the configuration of (1), (2), or (3) described above.

(10) Moreover, an embodiment of the invention is the lighting apparatus in which at least any one of a light input surface which faces the light source in the optical member and the top surface part is a rough surface, in addition to the configuration of (5) described above.

(11) Moreover, an embodiment of the invention is the lighting apparatus in which a side surface of the support body in the opening has an uneven surface, in addition to the configuration of (1), (2), or (3) described above.

(12) Moreover, an embodiment of the invention is the lighting apparatus in which the support part contains a scattering particle, in addition to the configuration of (1), (2), or (3) described above.

(13) Moreover, an embodiment of the invention is the lighting apparatus in which at least two or more support bodies are arranged, in addition to the configuration of (1), (2), or (3) described above.

(14) Moreover, an embodiment of the invention is the lighting apparatus in which the support body has the plurality of light sources all of which are arranged in the opening, in addition to the configuration of (1), (2), or (3) described above.

(15) Moreover, an embodiment of the invention is the lighting apparatus in which the support body has a plurality of openings, in addition to the configuration of (1), (2), or (3) described above.

(16) Moreover, an embodiment of the invention is the lighting apparatus in which two or more of the plurality of light sources are arranged in the at least one opening, in addition to the configuration of (1), (2), or (3) described above.

(17) Moreover, an embodiment of the invention is the lighting apparatus in which the support body is arranged in a striped pattern in the substrate, in addition to the configuration of (1), (2), or (3) described above.

(18) Moreover, an embodiment of the invention is a liquid crystal display apparatus including a display panel in the lighting apparatus, in addition to the configuration of (1), (2), or (3) described above.

### Advantageous Effects of Invention

According to an embodiment of the invention, even when a plurality of light sources are arranged with a narrow pitch, an optical member is prevented from being bent.

### BRIEF DESCRIPTION OF DRAWINGS

FIG. 1 is a plan view of a liquid crystal display apparatus including a lighting apparatus according to a first embodiment.

FIG. 2 is a plan view of the lighting apparatus according to the first embodiment.

FIG. 3 is a sectional view taken along a line A-A′ in FIG. 2.

FIG. 4 is a schematic sectional view illustrating a part of the liquid crystal display apparatus illustrated in FIG. 2.

FIGS. 5(a) and 5(b) are sectional views for explaining a distance between a light source and a side surface of a support body in an opening.

FIG. 6 is a schematic sectional view illustrating a part of a modified example different from the first embodiment.

FIG. 7 is a schematic sectional view illustrating a part of a liquid crystal display apparatus including a lighting apparatus according to a second embodiment.

FIG. 8 is a schematic sectional view illustrating a part of a liquid crystal display apparatus including a lighting apparatus according to a third embodiment.

FIG. 9 is a schematic sectional view illustrating a part of a liquid crystal display apparatus including a lighting apparatus according to a fourth embodiment.

FIG. 10 is a schematic sectional view illustrating a part of a liquid crystal display apparatus including a lighting apparatus according to a fifth embodiment when an optical member has a rough surface.

FIG. 11 is a schematic sectional view illustrating a part of the liquid crystal display apparatus including the lighting apparatus according to the fifth embodiment when the support body has a rough surface.

FIG. 12 is a schematic sectional view illustrating a part of a liquid crystal display apparatus including a lighting apparatus according to a sixth embodiment.

FIG. 13 is a schematic sectional view illustrating a part of a liquid crystal display apparatus including a lighting apparatus according to a seventh embodiment.

FIG. 14 is a plan view of a lighting apparatus according to an eighth embodiment.

FIG. 15 is a sectional view taken along a line A-A′ in FIG. 14.

FIG. 16 is a plan view of a lighting apparatus according to another embodiment.

FIG. 17 is a plan view of a lighting apparatus according to another embodiment.

### DESCRIPTION OF EMBODIMENTS

### First Embodiment

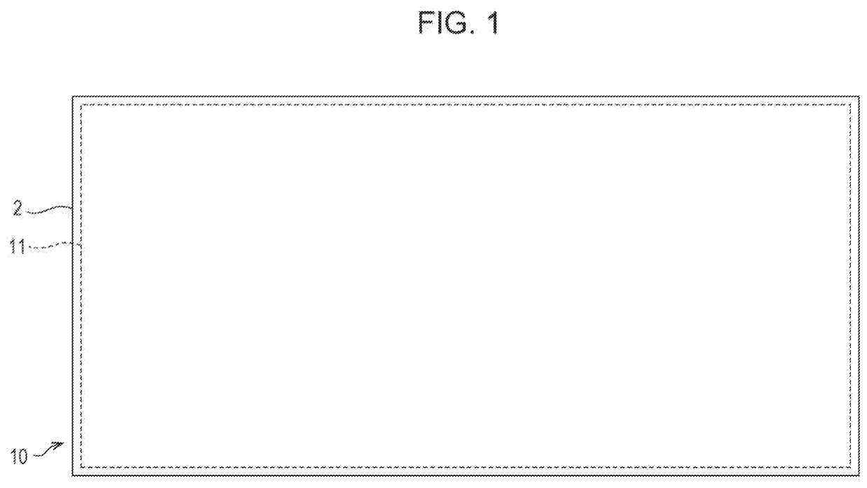

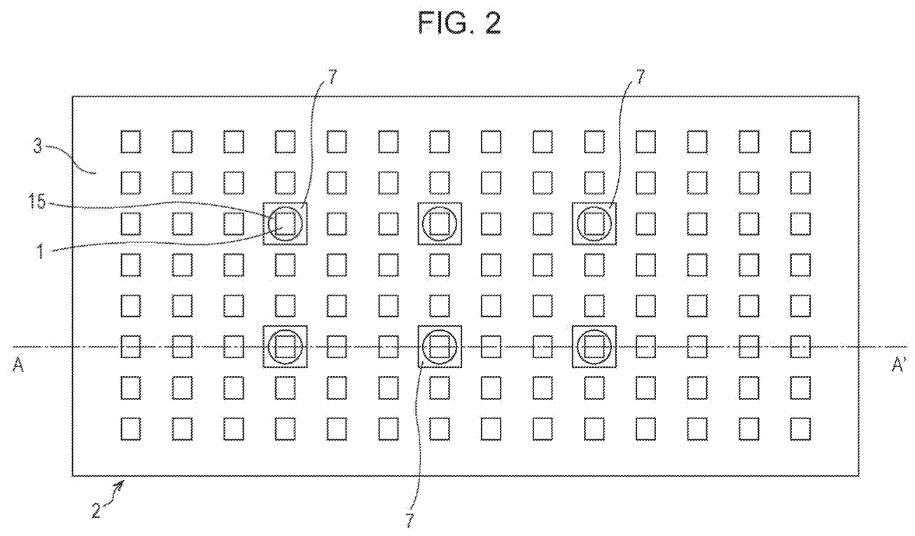

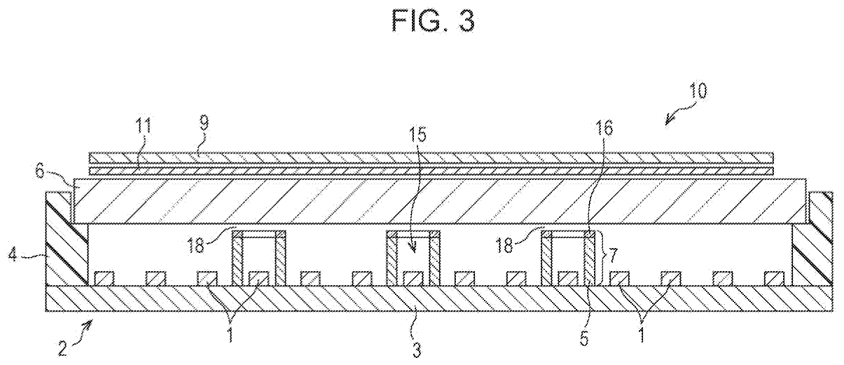

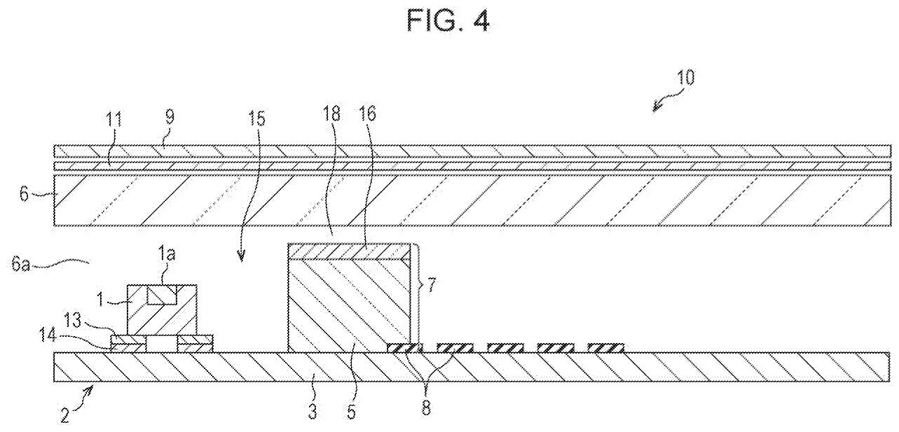

The present embodiment will be described with reference to FIGS. 1 to 4. FIG. 1 is a plan view illustrating a configuration of a liquid crystal display apparatus including a lighting apparatus according to the present embodiment. FIG. 2 is a plan view illustrating a configuration of the lighting apparatus according to the first embodiment. FIG. 3 is a sectional view taken along a line A-A′ in FIG. 2. FIG. 4 is a schematic sectional view illustrating a configuration of a part of the liquid crystal display apparatus illustrated in FIG. 2.

As illustrated in FIGS. 1 and 3, a liquid crystal display apparatus 10 has, for example, a rectangular shape in plan view and includes a liquid crystal panel 11, a transparent protection member 9, and a lighting apparatus 2 that functions as a backlight. Note that, the liquid crystal panel 11 may include a touch panel instead of the transparent protection member 9 or between the transparent protection member 9 and the liquid crystal panel 11.

Though detailed components are not illustrated in the figure, the liquid crystal panel 11 has a configuration in which a pair of glass substrates are bonded with a predetermined gap therebetween and liquid crystal is enclosed between both of the glass substrates.

The lighting apparatus 2 is arranged in a plate surface side opposite to a display surface of the liquid crystal panel 11. The lighting apparatus 2 includes an optical member 6, a support body 7, a light source 1, a substrate 3, and a frame 4.

(Optical Member)

The optical member 6 is arranged at a position facing the light source 1. The optical member 6 is a member that realizes a surface light source by making light emitted from the light source 1 uniform. Specific examples thereof include optical members such as a fluorescence light emission sheet (such as QDEF manufactured by 3M Company), a diffuser plate (such as a SUMISPEX opal plate manufactured by Sumitomo Chemical Co., Ltd), a diffuser sheet (such as D114 manufactured by TSUJIDEN Co., Ltd.), a prism sheet (such as BEF manufactured by 3M Company), and a polarization reflection sheet (such as DBEF manufactured by 3M Company). Moreover, such optical members 6 are layered in order of the fluorescence light emission sheet, the diffuser sheet, the prism sheet, and the polarization reflection sheet. Note that, in a case where a color of light emitted from the light source 1 is blue, the fluorescence light emission sheet is required. Thereby, high luminance is obtained.

(Substrate)

FIG. 4 is a schematic sectional view illustrating a part of the liquid crystal display apparatus 10. As illustrated in FIG. 4, a conductive pattern 8 is formed on a surface of the substrate 3. Further, the light source 1 and the substrate 3 are connected thorough an electrode part 14 and a solder part 13. Such a configuration makes it possible to electrically connect the light source 1 formed on the substrate 3 with an external power source. The substrate 3 is constituted by a material such as glass epoxy, aluminum, or polyimide. Note that, in a process of mounting the light source 1 on the substrate 3 as described below, the light source 1 reaches a high temperature, so that a heat-resistant material is preferably used for the substrate 3. In addition, a top of the substrate 3 is coated in white by white resist. Thereby, usage efficiency of light is enhanced.

(Light Source)

As illustrated in FIGS. 2 and 4, light sources 1 are provided in a matrix pattern in the substrate 3 and each have a light output surface 1a. Each of the light sources 1 is a top-view LED that emits white or blue light. Here, the top-view LED refers to an LED that has a light emission surface in a top surface direction. The light source 1 has a size of 0.05 to 1.0 mm. Further, the light sources 1 are provided in the matrix pattern in the substrate 3 and a pitch thereof is an interval of 1.0 to 5.0 mm. Such a configuration makes it possible to increase the number of light sources 1. Thereby, luminance is able to be enhanced. A shape of the light source 1 is a rectangular, square, elliptical, circular shape, or the like as viewed from a direction normal to the substrate 3.

The light source 1 is connected to the substrate 3 by solder. The lighting apparatus 2 in which the light source 1 is mounted on the substrate 3 by solder is able to be manufactured by, for example, a general reflow solder process or the like.

(Frame)

As illustrated in FIG. 3, the frame 4 is installed for the purpose of holding the optical member 6 and preventing light leakage as illustrated in FIG. 3. The frame 4 is formed by resin having a high reflectance or the like, and white polycarbonate is used as a representative. The color of white makes it possible to enhance the usage efficiency of light.

Meanwhile, for achieving high luminance in the lighting apparatus 2 of the direct type, by increasing the number of light sources 1 to be arranged, a high effect is obtained. However, when the number of light sources increases, an arrangement pitch is narrowed, so that the support body is difficult to be arranged as in a general lighting apparatus of a direct type. Thus, the support body 7 in the present embodiment has the following configuration.

(Support Body)

At least one or more support bodies 7 are arranged in the substrate 3 and the support body 7 is constituted by a support part 5. An opening 15 is open in a light output direction so as to correspond to at least one light source 1 as viewed from the direction normal to the substrate 3. The opening 15 is formed into the same shape as or a shape of almost the same type as the shape of the light source 1 in accordance with the shape of the light source 1. Note that, the opening 15 is formed by mold processing or drill processing.

That is, the support body 7 is arranged so as to surround at least one light source 1. For example, there is a case where the support body 7 surrounds two light sources 1 or the support body 7 surrounds a column of light sources 1. Further, a plurality of support bodies 7 are able to be arranged in the substrate 3. Such a configuration makes it possible to easily change design of the support body 7.

Examples of a shape of the support body 7 include square, rectangular, circular, rhombic, triangular shapes each having the opening 15 in a center part in plan view.

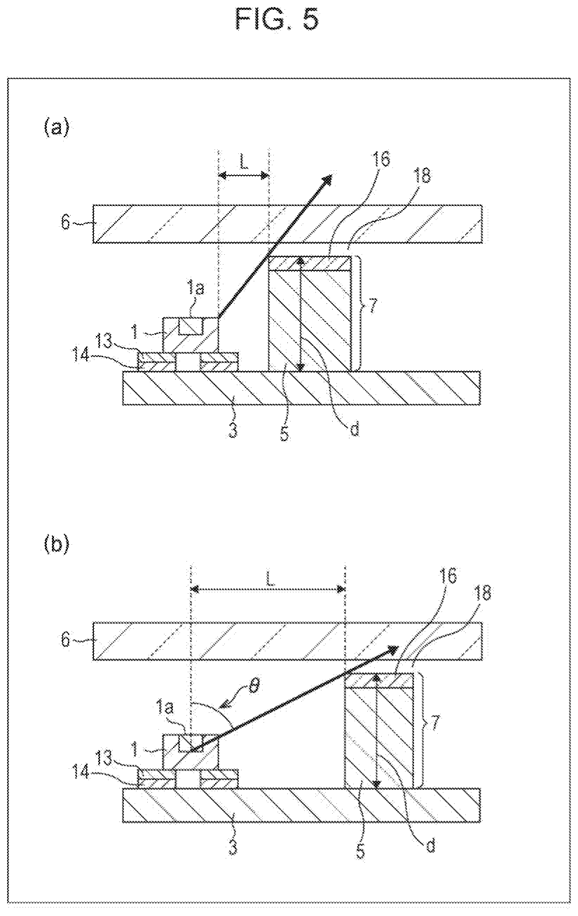

A distance between the light source 1 and a side surface of the support body 7 in the opening 15 will be described with reference to FIG. 5. FIGS. 5(a) and 5(b) are sectional views for explaining the distance between the light source 1 and the side surface of the support body 7 in the opening 15.

As illustrated in FIGS. 5(a) and 5(b), in a case where the distance between the light source 1 and the side surface of the support body 7 in the opening 15 is L and a height from the surface of the substrate 3 to the support body 7 is d, when the distance L<<the height d, most of light output from the light source 1 is incident on the support body 7 so that there is a concern that the usage efficiency of light is lowered. Since distribution of an angle of light emission of a general LED is ½ when the angle is about 60 degrees, design in which the light within 60 degrees from the normal direction is not incident on the support body 7 is preferable. That is, the height d/the distance L<0.577 (=tan 30°) is provided, and an upper limit of the height d/the distance L is ½ of a distance between adjacent light sources 1.

As illustrated in FIG. 4, a space layer 18 is disposed between the support body 7 and the optical member 6. When the space layer 18 is provided, it is possible to avoid a case where the support body 7 and the optical member 6 are close contact at an interface. Thereby, occurrence of Newton's rings is able to be prevented. Note that, design in which, only when the optical member 6 is bent by pressing or the like, the optical member 6 is supported by the support body 7 to prevent contact of the light source 1 and the optical member 6, and when there is no pressing, the space layer 18 is generated again is preferable.

The support part 5 has a top surface part 16 provided at a top surface and further has a light transmission property. Such a configuration makes it possible to minimize attenuation of light incident from the side surface of the support part 5 in the opening 15. Thereby, the usage efficiency of light is able to be enhanced. Examples of a main material by which the support body 7 has a light transmission property include acryl, polycarbonate, and PET.

In the present embodiment, as illustrated in FIG. 4, a height from the surface of the substrate 3 to the top surface part 16 of the support body 7 is higher than a height from the surface of the substrate 3 to the light output surface 1a of the light source 1. Such a configuration makes it possible to prevent the optical member 6 from being bent and further prevent contact of the light source 1 and the optical member 6. Here, a distance from the surface of the substrate 3 to the light output surface 1a of the light source 1 refers to a distance including the light source 1, the solder part 13, and the electrode part 14. On the other hand, a distance from the surface of the substrate 3 to the top surface part 16 of the support body 7 refers to a distance including the support body 7 and the conducive pattern 8. Note that, a height of only the light source 1 and a height of only the support body 7 are high to an extent that a thickness of another member is negligible, so that there is no problem in understanding that the light source 1<the support part 5.

Further, the support part 5 of the support body 7 has a columnar shape in sectional view. Thereby, it is possible to support the optical member 6 more stably.

(Manufacturing Method)

The support body 7 in the present embodiment is able to be manufactured as follows.

First, an optical sheet that is transparent and is thicker than the light source 1 is prepared (for example, a transparent polycarbonate sheet having a thickness of 0.3 mm). Then, the optical sheet is cut to have a size surrounding at least one light source 1 of a plurality of light sources 1. Next, an opening is provided at a portion corresponding to the light source 1 by mold processing. Further, the resultant is arranged in the substrate 3 so that the opening and the light source 1 match. As a result, the support body 7 in the present embodiment is able to be manufactured.

When the support body 7 in the present embodiment is provided, the optical member 6 is able to be supported and breakage of the light source 1 is able to be avoided. A high effect is exerted particularly in use, such as on-vehicle use or use in a mobile device, in which vibration is generated. It is also possible to prevent the optical member 6 from being locally bent and reduce luminance unevenness.

In addition, when trying to achieve reduction in thickness of a liquid crystal display apparatus including a normal lighting apparatus, a distance between a light source and an optical member is short and a problem of luminance unevenness is posed. In a case of the liquid crystal display apparatus 10 including the lighting apparatus 2 in the present embodiment, however, the plurality of light sources 1 are able to be arranged with a narrow pitch, thus making it possible to achieve reduction of the thickness.

### Modified Example

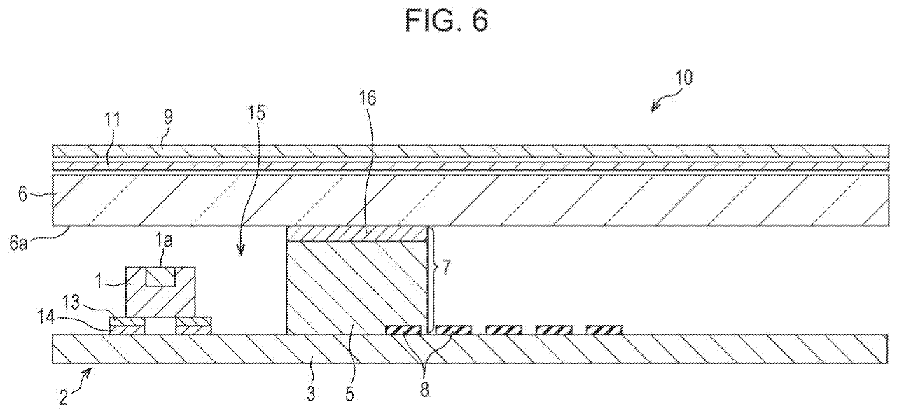

A modified example of the first embodiment will be described with reference to FIG. 6. FIG. 6 is a schematic sectional view illustrating a part of a configuration of the modified example of the first embodiment.

The top surface part 16 of the support body 7 may contact the optical member 6 arranged at the position facing the light source 1 as illustrated in FIG. 6. Here, the top surface part 16 is in surface contact with the optical member 6. Such a configuration increases a contact area compared to a case of point contact. Thereby, the optical member 6 is able to be supported more stably. Note that, though other embodiments when the top surface part 16 contacts the optical member 6 will be indicated below, the configuration is not necessarily limited to such a configuration.

### Second Embodiment

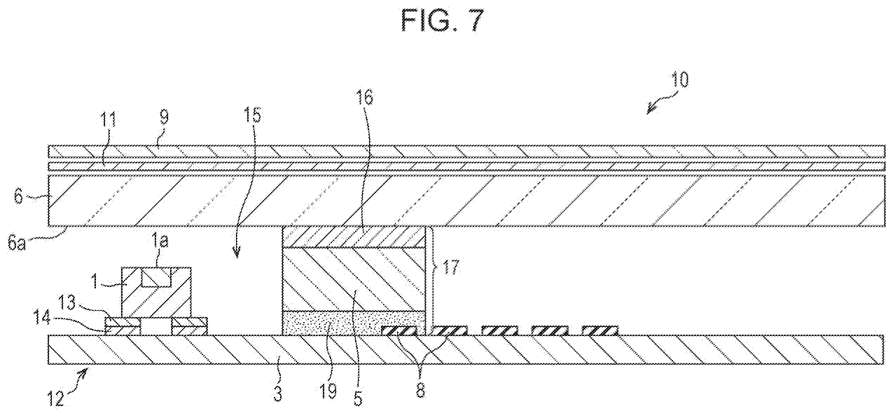

The present embodiment will be described with reference to FIG. 7. FIG. 7 is a schematic sectional view illustrating a part of a liquid crystal display apparatus including a lighting apparatus according to a second embodiment.

The present embodiment is different from the first embodiment in that a lighting apparatus 12 has a support body 17 including an adhesive layer 19 between the support part 5 and the substrate 3. That is, the support body 17 in the lighting apparatus 12 has the support part 5 and the adhesive layer 19.

The adhesive layer 19 in the present embodiment is arranged in at least a part of the substrate 3 as illustrated in FIG. 7. Thereby, an adhesive force between the support body 17 and the substrate 3 increases and the support body 17 is able to be fixed firmly.

Moreover, the adhesive layer 19 preferably has a light transmission property. Such a configuration makes it possible to prevent light from being absorbed in a surface or inside of the adhesive layer 19. Thereby, the usage efficiency of light is able to be enhanced.

### Third Embodiment

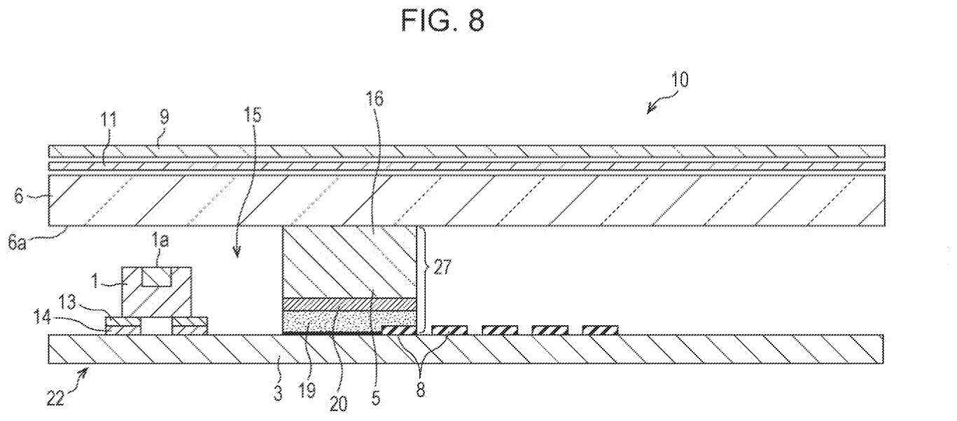

The present embodiment will be described with reference to FIG. 8. FIG. 8 is a sectional view illustrating a liquid crystal display apparatus including a lighting apparatus according to a third embodiment.

The present embodiment is different from the second embodiment in that a lighting apparatus 22 has a support body 27, which includes a reflection layer 20, between the support part 5 and the adhesive layer 19. That is, the support body 27 in the lighting apparatus 22 has the support part 5, the reflection layer 20, and the adhesive layer 19.

As illustrated in FIG. 8, the reflection layer 20 is provided in a substrate 3 side of the support body 27. Such a configuration makes it possible to highly efficiently reflect light guided in the support part 5. Thereby, the usage efficiency of light is able to be enhanced. Since an actual reflectance is higher than a case of being coated in white and provided in the substrate 3 as described below, the usage efficiency of light is enhanced.

As the reflection layer 20 in the present embodiment, white coating, a metal thin film made of aluminum, silver, or an alloy including them that has a high reflectance and is thin, a dielectric multilayer film in which light-transmissive materials having different refractive indexes are alternately layered, or the like is considered. In the present embodiment, since the thinner thickness enables to enhance the usage efficiency of light, the metal thin film is most preferably used. The thickness of the reflection layer 20 in this case is, for example, 0.1 μm to 10 μm or less.

The support body 27 in the present embodiment is able to be manufactured as follows. Note that, the same step as that of Embodiment 1 will be omitted.

First, silver is vapor-deposited with a thickness of 0.2 μm on one surface of an optical sheet. In this case, coating for increasing adhesiveness, a protection layer for protecting silver, a reflection enhancing film, or the like may be provided on a sheet side as needed. Then, an adhesive layer is applied onto a silver thin film and a release sheet is further attached thereto. Next, an opening is provided at a portion corresponding to the light source 1 by mold processing. Further, the release sheet is released to expose the adhesive layer and the resultant is attached to the substrate 3 so that the opening and the light source 1 match. As a result, the support body 27 in the present embodiment is able to be manufactured.

Note that, in the present embodiment, in a case where the reflectance of the reflection layer 20 is high, even when the adhesive layer is colored, the usage efficiency of light is not affected, so that the adhesive layer is able to be selected from a wider range and a more reliable material or the like is also able to be used.

### Fourth Embodiment

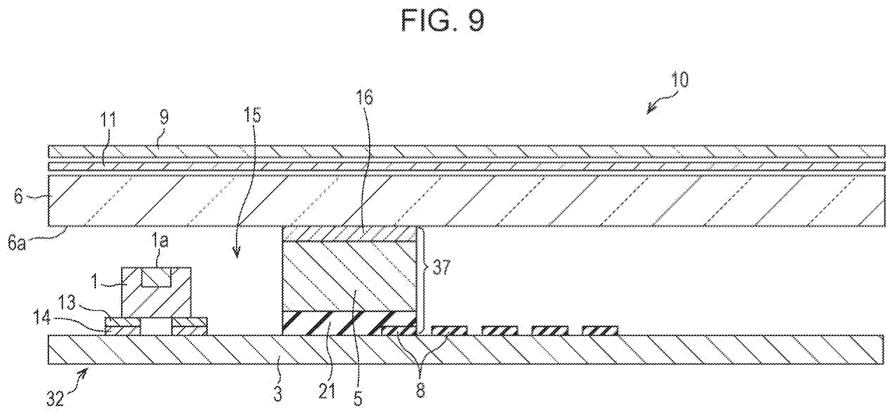

The present embodiment will be described with reference to FIG. 9. FIG. 9 is a schematic sectional view illustrating a part of a liquid crystal display apparatus including a lighting apparatus according to a fourth embodiment.

The present embodiment is different from the first embodiment in that a lighting apparatus 32 has a support body 37 that includes an insulating reflection surface 21 between the support part 5 and the adhesive layer 19. That is, the support body 37 in the lighting apparatus 32 has the support part 5 and the insulating reflection surface 21.

The insulating reflection surface 21 is obtained by coating the substrate 3 in white by white resist. The white coating is applied to a surface other than the electrode part 14. Thereby, the usage efficiency of light is able to be enhanced. Note that, the conductive pattern 8 is required to be an insulating material so as to be coated in white.

### Fifth Embodiment

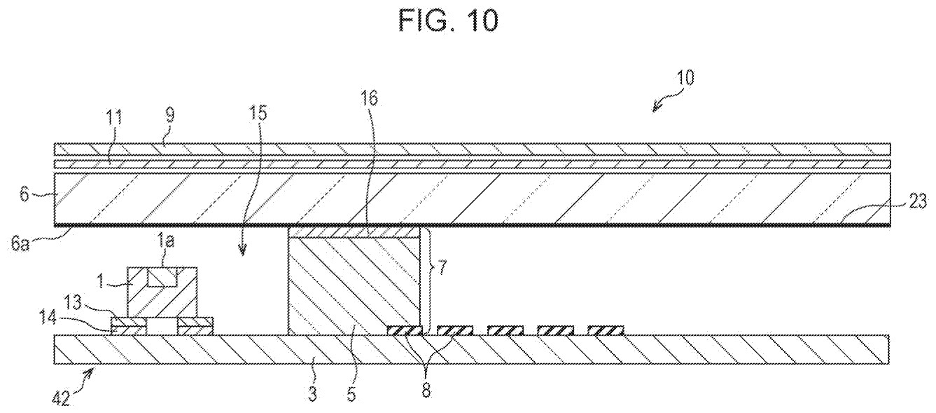

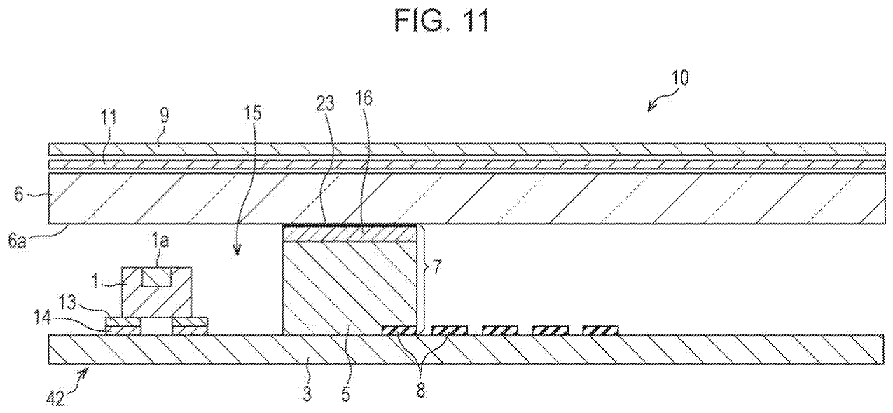

The present embodiment will be described with reference to FIGS. 10 and 11. FIG. 10 is a schematic sectional view illustrating a part of a liquid crystal display apparatus including a lighting apparatus according to a fifth embodiment when the optical member has a rough surface. FIG. 11 is a schematic sectional view illustrating a part of the liquid crystal display apparatus including the lighting apparatus according to the fifth embodiment when the support body 7 has a rough surface.

The present embodiment is different from the first embodiment in that at least one of a light input surface 6a of the optical member 6 and the top surface part 16 contacting the light input surface 6a is a rough surface 23 in a lighting apparatus 42. The light input surface 6a is a surface facing the light source 1 in the optical member 6. A roughness range of the rough surface 23 is, for example, Ra=0.2 μm to 10 μm. Such a configuration makes it possible to prevent Newton's rings that occur when the support body 7 and the optical member 6 are close contact at the interface. The Newton's rings refer to a concentric dark and light striped pattern that is seen as viewed from the direction normal to the substrate 3. Thereby, the usage efficiency of light is able to be enhanced. Note that, the rough surface 23 may be rephrased by matte, matting, non-glare, antiglare, or the like.

Moreover, when the top surface part 16 is the rough surface, an effect of extracting light that is incident from an edge surface of the support part 5 and guided into an inside is enhanced, thus making it possible to enhance the usage efficiency of light.

In addition, even a configuration in which the support body 7 and the optical member 6 are attached through adhesive without an air interface makes it possible to prevent occurrence of Newton's rings.

### Sixth Embodiment

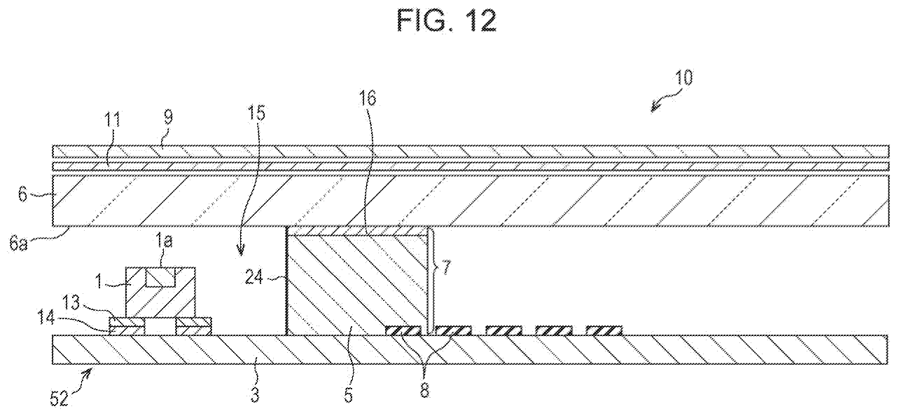

The present embodiment will be described with reference to FIG. 12. FIG. 12 is a schematic sectional view illustrating a part of a liquid crystal display apparatus including a lighting apparatus according to a sixth embodiment.

The present embodiment is different from the first embodiment in that a side surface of the support body 7 in the opening 15 has an uneven surface 24 in a lighting apparatus 52. Such a configuration makes it possible to enhance an effect of extracting light guided into an inside, so that the usage efficiency of light is able to be enhanced.

### Seventh Embodiment

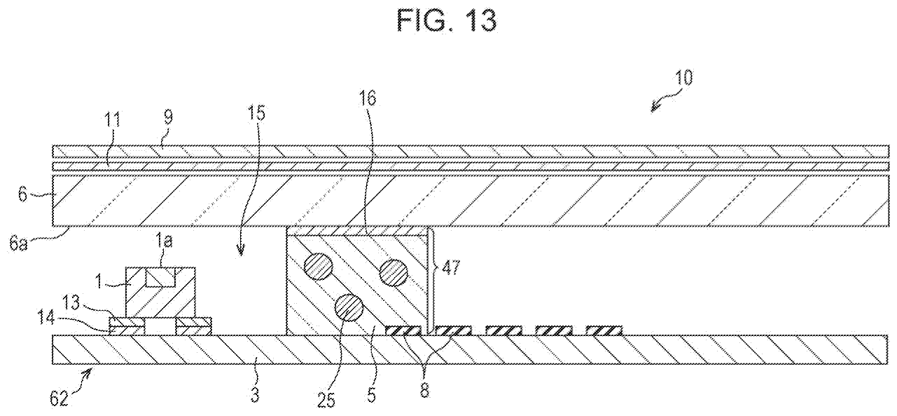

The present embodiment will be described with reference to FIG. 13. FIG. 13 is a schematic sectional view illustrating a part of a liquid crystal display apparatus including a lighting apparatus according to a seventh embodiment.

The present embodiment is different from the first embodiment in that the support pat 5 in a lighting apparatus 62 contains a scattering particle 25. Such a configuration makes it possible to achieve an effect of extracting light. Thereby, the usage efficiency of light is able to be enhanced.

### Eighth Embodiment

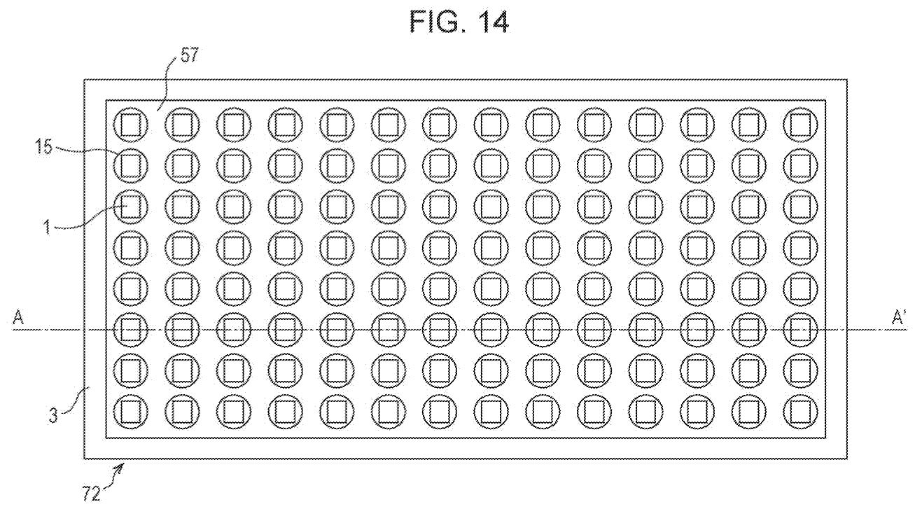

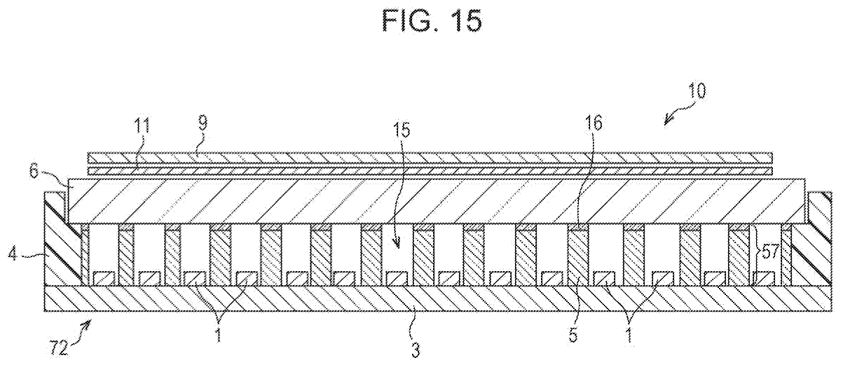

The present embodiment will be described with reference to FIGS. 14 and 15. FIG. 14 is a plan view of a lighting apparatus according to an eighth embodiment. FIG. 15 is a sectional view taken along a line A-A′ in FIG. 14.

The present embodiment is different from the first embodiment in that a support body 57 is formed in an entire surface of the substrate 3 as viewed from the direction normal to the substrate 3. That is, the support body 57 has a plurality of light sources 1 all of which are arranged in openings 15. Such a configuration makes it possible to arrange the support body 57 with a relatively wide area even when the light sources 1 are arranged with a narrow pitch. As a result, the optical member 6 is able to be supported without providing a fixing part in the support body 57.

### Another Embodiment

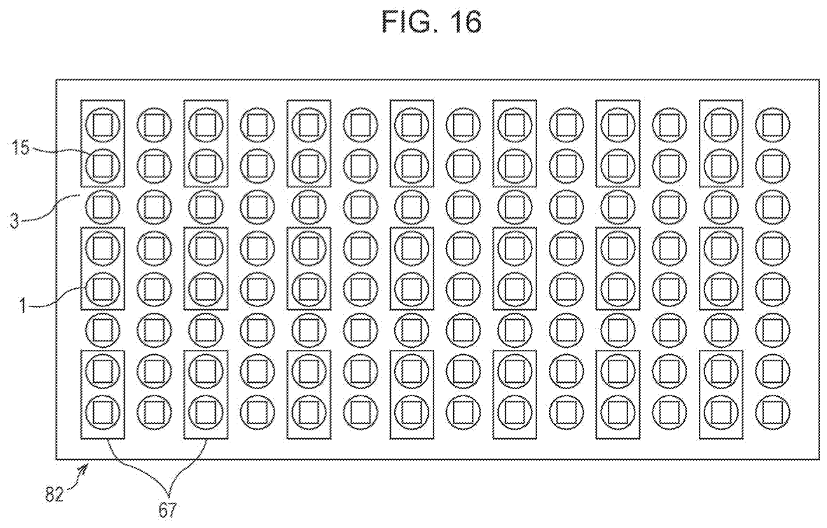

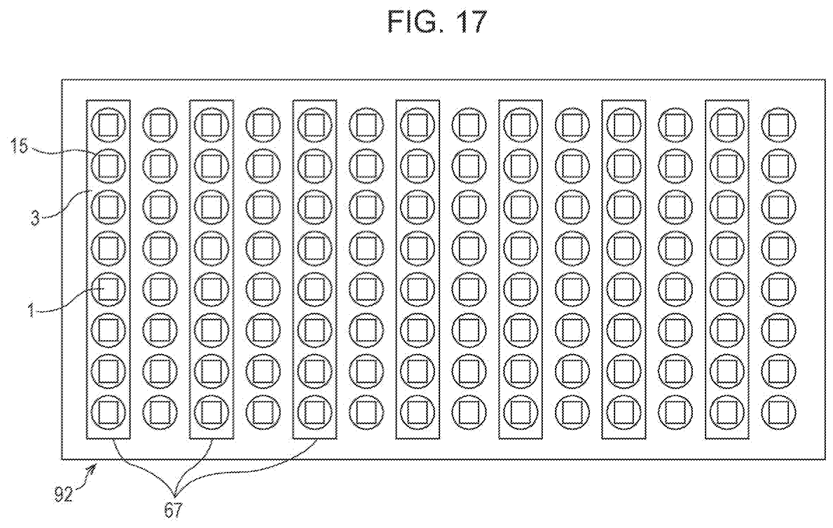

An aspect in which a support body 67 is disposed on the substrate 3 will be described as another embodiment with reference to FIGS. 16 and 17. FIGS. 16 and 17 are plan views of a lighting apparatus in such another embodiment.

As illustrated in FIG. 16, in a lighting apparatus 82, the support body 67 has an opening 15 provided so as to surround each of two light sources 1 of the plurality of light sources 1. Note that, a plurality of light sources 1 may be arranged in the opening 15 in the support body 67. That is, for example, a case where two light sources 1 are arranged in one opening 15 is assumed.

Further, as illustrated in FIG. 17, the support body 67 is formed in a striped pattern in the substrate 3 in a lighting apparatus 92. That is, the support body 67 has a shape extending in one specific direction and a plurality of support bodies 67 are arranged side by side in a direction orthogonal to such one specific direction. Thereby, the support bodies 67 are able to be formed even in a small space and are able to stably support the optical member 6. Further, the support bodies 67 do not need to be formed in the entire surface of the substrate 3, thus making it also possible to reduce manufacturing cost.

The invention is not limited to the embodiments described above and can be carried out in other various forms. The embodiments are therefore to be taken in all respects as exemplary only, and are not to be interpreted as being limiting. The scope of the invention is represented by the scope of the claims and is not restricted in any way to the specification itself. Furthermore, all variations and modifications falling within a range equivalent to the scope of the claims also fall within the scope of the invention.

### REFERENCE SIGNS LIST

1, light source
1a light output surface
2, 12, 22, 32, 42, 52, 62, 72, 82, 92 lighting apparatus
3 substrate
4 frame
5 support part
6 optical member
6a light input surface
7, 17, 27, 37, 47, 57, 67 support body
8 conductive pattern
9 transparent protection member (TP/cover glass)
10 liquid crystal display apparatus
11 liquid crystal panel
13 solder part
14 electrode part
15 opening
16 top surface part
18 space layer
19 adhesive layer
20 reflection layer
21 insulating reflection surface
23 rough surface
24 uneven surface
25 scattering particle
d height from surface of substrate to support body
L distance from light source to side surface of support body in opening
θ viewing angle of light source

1. A lighting apparatus comprising:
a substrate;
a plurality of light sources each of which has a light output surface and which are arranged on the substrate;
an optical member that is arranged at a position facing the light output surface of each of the light sources; and
a support body that supports the optical member and has a height from a surface of the substrate higher than a height to the light output surface, wherein
the support body is arranged between the substrate and the optical member,
and includes a support part that has a light transmission property and
an opening corresponding to at least one of the plurality of light sources as viewed from a direction normal to the substrate.

2. The lighting apparatus according to claim 1, wherein the support body includes an adhesive layer arranged between the support part and the substrate.

3. The lighting apparatus according to claim 2, wherein the support body includes a reflection layer arranged between the support part and the adhesive layer.

4. The lighting apparatus according to claim 1, wherein the support body includes an insulating reflection surface arranged between the support part and the substrate.

5. The lighting apparatus according to claim 1, wherein the support part includes a top surface part provided at a top surface.

6. The lighting apparatus according to claim 5, wherein the top surface part contacts the optical member.

7. The lighting apparatus according to claim 2, wherein the adhesive layer has a light transmission property.

8. The lighting apparatus according to claim 3, wherein a thickness of the reflection layer is 0.1 to 10 m or less.

9. The lighting apparatus according to claim 1, wherein a shape of the opening is circular as viewed from the direction normal to the substrate.

10. The lighting apparatus according to claim 5, wherein at least any one of a light input surface which faces the light source in the optical member and the top surface part is a rough surface.

11. The lighting apparatus according to claim 1, wherein a side surface of the support body in the opening has an uneven surface.

12. The lighting apparatus according to claim 1, wherein the support part contains a scattering particle.

13. The lighting apparatus according to claim 1, wherein at least two or more support bodies are arranged.

14. The lighting apparatus according to claim 1, wherein the support body has the plurality of light sources all of which are arranged in the opening.

15. The lighting apparatus according to claim 1, wherein the support body has a plurality of openings.

16. The lighting apparatus according to claim 1, wherein two or more of the plurality of light sources are arranged in the at least one opening.

17. The lighting apparatus according to claim 1, wherein the support body is arranged in a striped pattern in the substrate.

18. A liquid crystal display apparatus including a display panel in the lighting apparatus according to claim 1.
